(19) United States
(12) Patent Application Publication
(10) Pub. No.: US 2021/0124655 A1
(43) Pub. Date: Apr. 29, 2021

(54) Dynamic Configurable Microcontroller Recovery

(71) Applicant: NXP USA, Inc., Austin, TX (US)

(72) Inventors: Andrew Edward Birnie, Bearsden (GB); Steven Bruce McAslan, Glasgow (GB); David McDaid, Glasgow (GB)

(73) Assignee: NXP USA, Inc., Austin, TX (US)

(21) Appl. No.: 16/665,384

(22) Filed: Oct. 28, 2019

(51) Int. Cl. G06F 11/14

(52) U.S. Cl. CPC G06F 11/1471; G06F 2201/85; G06F 11/1441

(57) ABSTRACT

An error recovery system, method, and apparatus are provided for a microcontroller unit (100) having a plurality of components (101-109) by assigning error recovery actions to at least a first MCU component to specify a component-specific operation for returning the first MCU component to a known state to restart operation of the first MCU component from the known state, and then storing the assigned error recovery actions in a recovery lookup table (122) so that a fault collection and control unit can use a hardware state machine (121) to evaluate an error signal received from an MCU component for determining an error type and location for the MCU component which are applied to the recovery lookup table to retrieve and apply the error recovery actions to return the first MCU component to the known state without restarting all other components on the MCU.

### BACKGROUND OF THE INVENTION

### Field of the Invention

The present disclosure is directed in general to field of microprocessor operation. In one aspect, the present disclosure relates to the management of faults and errors in multi-element microcontroller systems.

### Description of the Related Art

With computer systems which incorporate different system components and applications into a single integrated system, there are increasingly complex challenges to the ability to monitor and control the different components and applications. For example, with current trends in the automotive industry toward providing vehicle autonomy, electrification, and connectivity, automotive vehicles now include integrated circuit computer systems—such as electronic control units (ECUs), microcontrollers (MCUs), System(s)-on-a-Chip (SoC), and System(s)-in-a-Package (SiP)—which host applications having safety-critical tasks, such as steering control, braking control, autonomous driving, or the like. With increasing levels of system integration resulting in multi-core devices being integrated with other system elements or components in a single computer system, any operational faults or errors at one system component or element can disrupt the operation of the overall computer system. For example, an error or fault detected at one component of an MCU is often resolved by using a master reset process whereby the system performs a hardware reset which causes the system to re-start from its initial configuration. Although this initial configuration is a safe state, it results in the erasure or discarding of all of the information stored on the system components, hence getting back to the state where the fault occurred can take a considerable length of time. Unfortunately, this can result in significant downtime to computer system operation that is cause by a fault or error that affects only one of the computer system components. As seen from the foregoing, the existing computer system solutions for resolving faults and error are extremely difficult at a practical level by virtue of the challenges of providing an error or fault monitoring and recovery capability without reducing operational performance or imposing additional costs, excessive overhead, and complexity of additional hardware and software.

### BRIEF DESCRIPTION OF THE DRAWINGS

The present disclosure may be understood, and its numerous objects, features and advantages obtained, when the following detailed description of a preferred embodiment is considered in conjunction with the following drawings.

FIG. 1 is a simplified schematic block diagram illustration of a computer system with a dynamically configurable recovery engine having a hardware state machine and recovery action lookup table in accordance with selected embodiments of the present disclosure.

FIG. 2 is a simplified flow chart showing the logic for configurably defining recovery actions for each element of a microcontroller unit in accordance with selected embodiments of the present disclosure.

FIG. 3 is a decision tree for a fault collection and control unit in accordance with selected embodiments of the present disclosure.

### DETAILED DESCRIPTION

A high-performance, cost-effective, dynamically configurable recovery system, apparatus, architecture, and methodology are described for quickly recovering from microcontroller system errors and faults with a minimum disruption to system operations. In selected embodiments, the dynamically configurable recovery system uses a recovery lookup table to store specific recovery actions for each component of the microcontroller system so that, upon detection of an error or fault occur at an MCU system component, the recovery lookup table may be accessed to retrieve a specified recovery action to get the affected MCU system component to a known state as quickly as possible for re-starting operation from that state. By providing a configurable recovery lookup table, each MCU system component can have a different recovery path of getting to a known state. And by including a hardware state machine to determine the type and location of each fault or error, the recovery actions retrieved from the recovery lookup table can be transferred or conveyed directly to the affected MCU system component. In this way, a detected error or fault affecting only one small area or component of the MCU system can be recovered while leaving the other MCU system components running, thereby avoiding a master reset and attendant delays. Suitable applications include, but are not limited to, control and operation of an MCU that is responsible for controlling safety critical tasks, such as autonomous driving, where faults and errors occasionally occur and can be recovered from quickly by providing a dynamically configurable recovery mechanism for whatever fault or error that has occurred at any MCU system component under any specified use case.

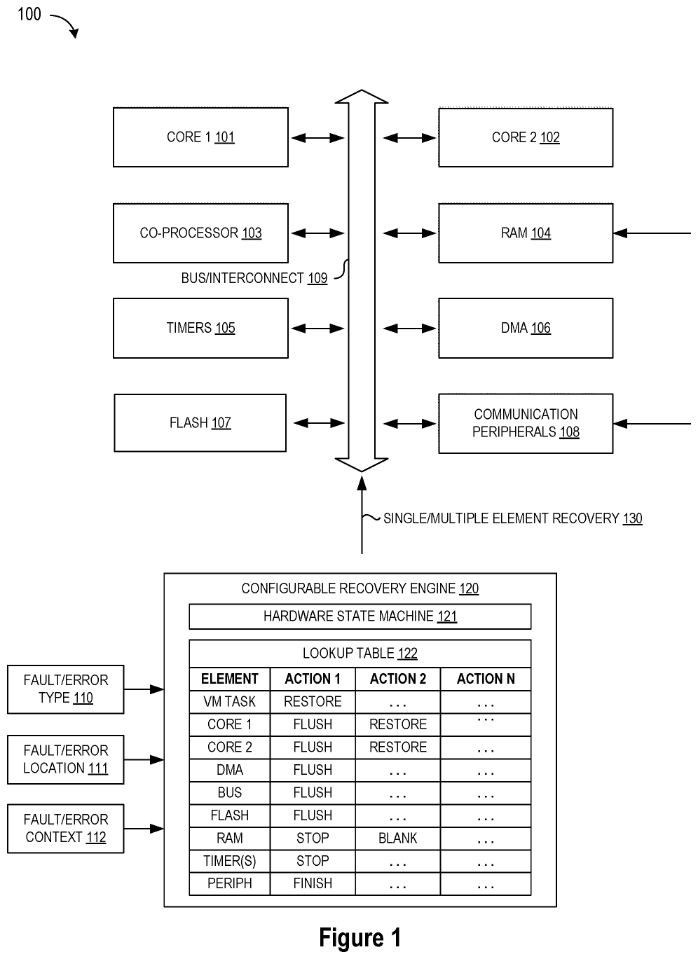

To provide additional details for an improved understanding of selected embodiments of the present disclosure, reference is now made to FIG. 1 which is simplified schematic block diagram illustration of a computer system 100 with a dynamically configurable recovery engine 120 that includes a hardware state machine 121 and recovery action lookup table 122 that are connected and configured to provide component-specific recovery from detected faults or errors, thereby providing faster fault responses and higher system performance by avoiding system-wide reset or restart recoveries. As depicted, the computer system 100 can be implemented as or incorporated into various devices, such as various types of vehicle computer systems (e.g., Electronic/Engine Control Module, Powertrain Control Module, Transmission Control Module, Brake Control Module), a personal computer (PC), a tablet PC, a set-top box (STB), a personal digital assistant (PDA), a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that machine. The computer system 100 may be implemented using electronic devices that provide voice, audio, video or data communication. While a single computer system 100 is illustrated, the term “system” may include any collection of systems or sub-systems that individually or jointly execute a set, or multiple sets, of instructions to perform one or more computer functions. As described hereinbelow, the computer system 100 may include a set of instructions that can be executed to cause the computer system 100 to perform any one or more of the methods or computer-based functions disclosed.

The depicted computer system 100 may include one or more processor cores 101, 102 and/or co-processors, such as a central processing unit (CPU), a graphics processing unit (GPU), or both. The processor/core component(s) 101-103 may be a component in a variety of systems and may be implemented with one or more general processors, digital signal processors, application specific integrated circuits, field programmable gate arrays, servers, networks, digital circuits, analog circuits, combinations thereof, or other now known or later developed devices for analyzing and processing data. In selected embodiments, each of the processor/core component(s) (e.g., 101) has signal lines for at least an address signal line, data signal line, and sideband signal line that are connected over a crossbar interconnect bus 109 to one or more system resources 102-109. Though not shown, it will be appreciated that the signal lines may be provided as separate signal lines between the system resources 101-109 or may be implemented over shared signal lines using time interleaving.

In the depicted embodiment, the computer system 100 is implemented with a multi-core processor design where each processor 101-103 may implement a software module or program, such as code generated manually or programmed. The term “module” may be defined to include a number of executable modules. The modules may include software, hardware or some combination thereof executable by a processor/core 101-103. Software modules may include instructions stored in memory, such as memory 104, or another memory device, that may be executable by the processor/core(s) 101-103. Hardware modules may include various devices, components, circuits, gates, circuit boards, and the like that are executable, directed, and/or controlled for performance by the processor/core(s) 101-103.

The computer system 100 may include a memory, such as a random access memory (RAM) 104 that can communicate via a crossbar bus or interconnect 109. The memory 104 may be a main memory, a static memory, or a dynamic memory. The memory 104 may include, but is not limited to computer readable storage media, such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 104 includes a buffer memory (e.g., an internal FIFO buffer memory), a cache, or random access memory for the processor/core(s) 101-103. In alternative examples, the memory 104 may be separate from the processor/core(s) 101-103, such as a cache memory of a processor, the system memory, or other memory. The memory 104 may include a disk or optical drive unit, an external storage device or database for storing data. Examples include a hard drive, compact disc (“CD”), digital video disc (“DVD”), memory card, memory stick, floppy disc, universal serial bus (“USB”) memory device, or any other device operative to store data. The memory 104 is operable to store instructions executable by the processor/core(s) 101-103. The functions, acts or tasks illustrated in the figures or described may be performed by the programmed processor/core(s) 101-103 executing the instructions stored in the memory 104. The functions, acts, or tasks may be independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

A computer readable medium or machine-readable medium may include any non-transitory memory device that includes or stores software for use by or in connection with an instruction executable system, apparatus, or device. The machine-readable medium may be an electronic, magnetic, optical, electromagnetic, infrared, or semiconductor system, apparatus, or device. Examples may include a portable magnetic or optical disk, a volatile memory such as a random access memory, a read-only memory (ROM), or an Erasable Programmable Read-Only Memory (EPROM) or Flash memory. A machine-readable memory may also include a non-transitory tangible medium upon which software is stored. The software may be electronically stored as an image or in another format (such as through an optical scan), then compiled, or interpreted or otherwise processed.

As described hereinabove, each of the processor/core(s) 101-103 and/or memory 104 serves as a resource for the computer system 100, but it will be appreciated that the computer system 100 may include other system resources or components. For example, one or more timers 105 may be included as a system resource for tracking the temporal duration of a system transaction, such as the execution time, stall time, or other timer tasks. In addition or in the alternative, a DMA controller 106 may be included as a system hardware resource that allows a peripheral input/output (I/O) device to send or receive data directly to or from the main memory, bypassing the processor/core(s) 101-103 to speed up the corresponding memory operations. In addition or in the alternative, a flash memory module 107 may be included as a system memory resource which enables high speed access to CPU instructions that are stored in an electrically erasable and reprogrammable read only memory storage medium. In addition or in the alternative, one or more additional communication peripherals 108 may be included as system resources, such as a graphics controller for a display or video device, one or more USB devices, a keyboard or trackpad, a wireless or Bluetooth transceiver, a camera or audio device, an Ethernet controller, and the like.

As will be appreciated, faults and errors do occasionally occur with any system component, so it is important to recover from the errors quickly with the minimum of disturbance. For example, a fault can occur during an initial transaction between a first resource (e.g., core 101) and a second resource (e.g., memory 104) or during a subsequent operation of the second resource initiated by the transaction. In one example where the second resource is a memory (e.g., a RAM 104), a processor that attempts to read the memory may detect a failure by a comparison of a parity bit, check-sum or Error Detection and Correction (EDC) circuit. In another example where the second resource is a timer 105, a timer may be started by a transaction from a first resource (e.g., core 101), only to fail (and generate a fault) at a later time when the a first resource (e.g., core 101) has begun execution of a new application that does not require a transaction with the timer 105. In another example where the second resource is a DMA controller 102, a read or write operation being handled by the DMA 102 may encounter a memory address conflict midway through a data transfer operation, thereby generating a fault or error signal. When errors or faults occur on the MCU system 100, the system needs to get to a known state as soon as possible and to re-start operation from that condition. However, each element 101-109 on the MCU system 100 has a different path of getting to a known state. In addition, each error may only affect one small area or component of the MCU system 100, in which case it may only be necessary to recover the specific section or component where the error occurred, leaving the other components or areas running, thereby avoiding a master reset operation which restarts all system components.

To provide a dynamic and configurable recovery mechanism which specifically addresses detected faults or errors on an element-by-element basis with fast recovery actions that are tailored to the specific element fault/error, the computer system 100 may include a configurable recovery engine 120 (or similar error handler) as part of a fault collection and control unit (FCCU) functionality which responds to fault/error information to implement specified recovery actions. For example, when a fault occurs at one or more of the system elements 101-109, a fault indication is stored at the element(s). Upon detection of a fault in the system element(s) by the status of the fault indication, a fault or error signal is generated to provide fault/error information to the recovery engine 120. In selected embodiments, the fault/error signal may include a first signal 110 specifying the type of error/fault (e.g., ECC error, check-sum error, parity bit error, address conflict, etc.), a second signal 111 specifying the location of the error/fault (e.g., which MCU element generated the fault/error), and/or a third signal 112 specifying the relevant context information for the error/fault (e.g., during bootup, runtime, standby, etc.). In other embodiments, the component where an error or fault is detected transmits the fault indication which includes pertinent information regarding the fault including, but not limited to, the type of fault, the time that the fault occurred, and various other parameters necessary to characterize or reproduce the fault conditions.

To configurably apply one or more element-specific recovery actions to a fault or error detected at a system component, the recovery engine 120 may include an error/fault detector state machine 121 (which evaluates the type and location of any detected fault/error) and one or more recovery lookup tables 122 (which specify recovery actions to be performed on each element of the system). Examples of recovery actions are shown in Table 1:

Recovery Action

Restore (known good context)
Flush (pending transactions/pipelines/cache)
Blank (write 00 to memory range)
Stop (all read/write operations instantly)
Finish (current operation then stop)

By using the recovery lookup table 122 to store recovery actions, element-specific recovery actions may be specifically defined for each element and specific recovery action sequences for particular faults or errors may be configured on an element-by-element basis. An example of a recovery lookup table 122 is shown in Table 2:

| Element | Action 1 | Action 2 |
|---|---|---|
| Virtual Machine (task running on a core) | Restore | |
| Core 1 | Flush | Restore |
| Core 2 | Flush | Restore |
| DMA | Flush | |
| Interconnect | Flush | |
| Flash | Flush | |
| RAM | Stop | Blank |
| Timers | Stop | |
| Communications Peripheral | Finish | |

In operation, the fault/error detector state machine 121 evaluates the fault/error information 110-112 to determine the element or location of the failure (e.g., which core or memory component failed), the type of failure (e.g., transient or permanent fault, lock step error, etc.), and any relevant contextual information (e.g., which core or virtual machine element is operating on the failing element). Using the detected fault/error information 110-112, the recovery engine 120 uses the fault/error detector state machine 121 to access one or more recovery lookup tables 122 to retrieve and forward otherwise signal one or more specified recovery actions 130 in response to the fault/error signal/indication, thereby generating an element-specific recovery action 130 that is appropriate to the source and type of fault indicated. While the fault/error detector state machine 121 may be implemented with a dedicated processor core running software, selected embodiments of the state machine 121 are implemented in hardware with control logic gates which embody the fault/error detection and recovery functionality for evaluating the type and location of the fault/error to retrieve one or more recovery actions from the recovery lookup table(s) 122 and to then transfer the determined recovery action(s) from the recovery lookup table 122 to the corresponding MCU system component.

With reference to the example recovery lookup table shown in Table 2, the recovery engine 120 generates a recovery action 130 for one or more system elements, depending on the type, location, and context of the fault or error. If the fault was caused by a virtual machine task running on a core element, a single “restore” recovery action is specified in the recovery table for the reference virtual machine element. In another example, if the fault source is from a built-in self test (BIST) application that was run with a thread on the first core (Core 1), then the specified recovery action from the recovery table includes a first “flush” recovery action (to flush pending transactions/pipelines/cache from the first core) and a second “restore” recovery action (to return the first core to a known good context). Or if the fault source is a lockstep failure that was run with a thread on the second core (Core 2), then the specified recovery action from the recovery table may include a sequence of a “flush” recovery action (to flush pending transactions/pipelines/cache from the second core) and a second “restore” recovery action for the second core. In another example, if the fault was caused by a direct memory access operation at the DMA controller element, a single “flush” recovery action is specified in the recovery table for flushing memory address registers at the DMA controller. Similarly, if the fault was caused by an access or conflict at the interconnect bus element, a single “flush” recovery action is specified in the recovery table for flushing pending transactions on the bus. In another example, if the fault was caused by a write or read operation at the flash memory element, a single “flush” recovery action is specified in the recovery table for flushing memory address or data registers at the flash memory. In another example, if the fault source stems from a failed Error Correction Code (ECC) during access to the RAM element, then the specified recovery action from the recovery table may include a sequence of a “stop” recovery action (to immediately pause all read/write operations to the affected memory address range at the memory element) and a second “blank” recovery action to write predetermined values (e.g., 00) to the affected memory address range. In yet another example, if the fault was caused by a timer which is started but subsequently fails at a later time, a single “stop” recovery action is specified in the recovery table to immediately pause all operations at the timer element. Finally, if the fault was caused by a communications peripheral, a single “finish” recovery action is specified in the recovery table to complete the current operation and then stop.

Once the recovery engine 120 generates and transmits the recovery action(s) 130 to the system component(s) where the fault/error occurred, the specified recovery action is performed at the affected system component, such as by using in-built circuitry to perform the recovery action. In most cases, the identified recovery actions can be performed with existing circuitry at the system component. However, in selected embodiments, a side band signal is provided to the affected system component to initiate the recovery action generated by the fault/error detector state machine 121.

In selected embodiments, the recovery engine 120 may be implemented in whole or in part with dedicated hardware, such as application specific integrated circuits, programmable logic arrays and other hardware devices, may be constructed to implement various parts of the system. Applications that may include the apparatus and systems can broadly include a variety of electronic and computer systems. One or more examples described may implement functions using two or more specific interconnected hardware modules or devices with related control and data signals that can be communicated between and through the modules, or as portions of an application-specific integrated circuit. The computer system 100 encompasses software, firmware, and hardware implementations. The system described may be implemented by software programs executable by a computer system. Implementations can include distributed processing, component/object distributed processing, and parallel processing. Alternatively, virtual computer system processing can be constructed to implement various parts of the system.

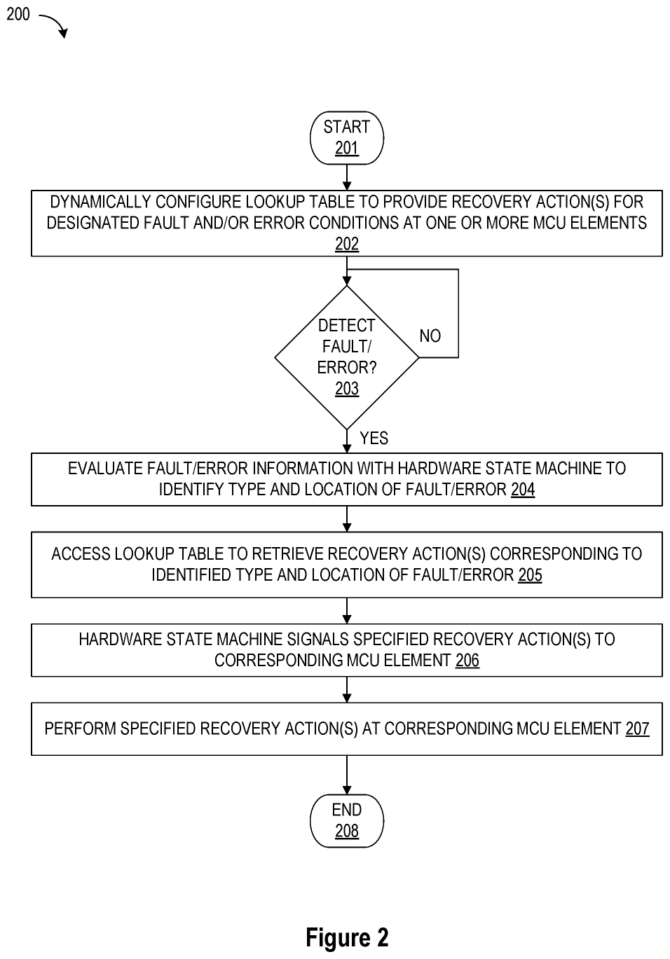

To provide additional details for an improved understanding of selected embodiments of the present disclosure, reference is now made to FIG. 2 which depicts a simplified flow chart diagram 200 showing the logic for configurably defining recovery actions for each element of a microcontroller unit, such as may be used by a fault collection and control unit. In the flow diagram 200, the method starts at step 201 and the MCU device undergoes a device configuration process, such as when an MCU device is configured with one or more recovery actions for responding to an error or fault by restoring the MCU device to a know good or starting state. As will be appreciated, the device configuration process will typically occur as part of or prior to the normal operation of an MCU device.

At step 202, a lookup table is dynamically configured to specify one or more recovery actions for designated fault and/or error conditions at one or more elements of the MCU device. In selected embodiments, a fault collection and control unit on the MCU device may be configured to program lookup table values to specify a list of actions to be performed on one or more specified MCU elements where a fault or error is detected. For example, each row of the lookup table may correspond to a specified MCU element, and the entry or entries in each row may specify the recovery action(s) for the specified MCU element.

At step 203, normal operation of the MCU device starts, and at step 204, a fault or error is detected at one of the MCU elements. If no fault is detected (negative outcome to detection step 204), then the MCU device continues to operation normally. However, when a fault or error is detected (affirmative outcome to detection step 204), then the fault collection and control unit evaluates the fault/error information to identify the type and location of the fault/error (step 205). As disclosed herein, the evaluation step may receive the fault indication which signals the failure location, type, and context. To expedite the evaluation process, the evaluation may be implemented with a hardware state machine implemented with logic gates in the fault collection and control unit to shorten the recovery process by quickly identifying the MCU element where the fault/error occurred, as well as the required recovery lookup table for retrieving one or more specified recovery actions.

At step 206, a recovery lookup table is accessed to retrieve one or more recovery actions corresponding to the identified type and location of the detected fault or error. In selected embodiments, the hardware state machine may be embodied to access a single row in a specified recovery lookup table to retrieve the recovery action for a single MCU element. However, in other embodiments, the hardware state machine may be embodied to access an entire recovery lookup table to retrieve recovery actions for a plurality of elements specified in the recovery table.

More generally, it will be appreciated that multiple recovery lookup tables can be accessed based on the identified fault/error information, where each table defines a group of MCU elements and associated recovery actions. For example, a first recovery lookup table may be defined as follows to recover from faults detected at all of the MCU elements, such as set forth below in Table 3:

| | | | |
|---|---|---|---|
| Element | Action 1 | Action 2 | Action N |

| | | |
|---|---|---|
| Virtual Machine | Restore | |
| Core 1 | Flush | Restore |
| Core 2 | Flush | Restore |
| DMA | Flush | |
| Interconnect | Flush | |
| Flash | Flush | |
| RAM | Stop | Blank |
| Timers | Stop | |
| Communications Peripheral | Finish | |

In addition, a second recovery lookup table may be defined as follows to recover from faults detected at all of the MCU elements, such as set forth below in Table 4:

| | | | |
|---|---|---|---|
| Element | Action 1 | Action 2 | Action N |

| | | |
|---|---|---|
| Virtual Machine | Restore | |
| Core 1 | Flush | Restore |
| Core 2 | Flush | Restore |
| DMA | Flush | |
| Interconnect | Flush | |
| Flash | | |
| RAM | | |
| Timers | | |
| Communications Peripheral | | |

In addition, a third recovery lookup table may be defined as follows to recover from faults detected at all of the MCU elements, such as set forth below in Table 5:

| | | | |
|---|---|---|---|
| Element | Action 1 | Action 2 | Action N |

| | |
|---|---|
| Virtual Machine | |
| Core 1 | |
| Core 2 | |
| DMA | Flush |
| Interconnect | Flush |
| Flash | Flush |
| RAM | |
| Timers | |
| Communications Peripheral | |

With multiple recovery lookup tables (e.g., 8) stored on the fault collection and control unit, the fault recovery can select one table (e.g., Table 3) to specify a single MCU element and associated recovery action or to specify recovery actions for all of the MCU elements in the table. Alternative, by accessing a Table 4 as the recovery lookup table, the recovery actions for a specified group of MCU elements can be accessed as specified in the table. In the example of Table 4, the recovery table provides recovery actions for the virtual machine (restore), core 1 (flush and restore), core 2 (flush and restore), DMA (flush), and interconnect bus (flush). Similarly, access to Table 5 as the recovery lookup table can access a different set of recovery actions for a specified group of MCU elements, namely the DMA (flush), interconnect bus (flush), and flash memory (flush) as specified in the table.

At step 207, the fault collection and control unit may use the hardware state machine to signal the recovery action(s) specified by the lookup table access to the corresponding MCU element. As disclosed herein, the hardware state machines may signal the recovery action(s) using one or more signal lines that are connected to each corresponding MCU element.

At step 208, the recovery action(s) specified by the fault collection and control unit are performed at the corresponding MCU element. As disclosed herein, each MCU element may include circuitry to act on the prescribed recovery action(s), such as restoring, flushing, blanking, stopping, and finishing.

At step 209, the process stops. Alternatively, the process returns to step 202 in response to any additional configuration of the lookup table, thereby supporting dynamic configuration of the lookup table. In addition or in the alternative, the process returns to step 203 to continue normal operation of the microcontroller unit until another fault or error is detected.

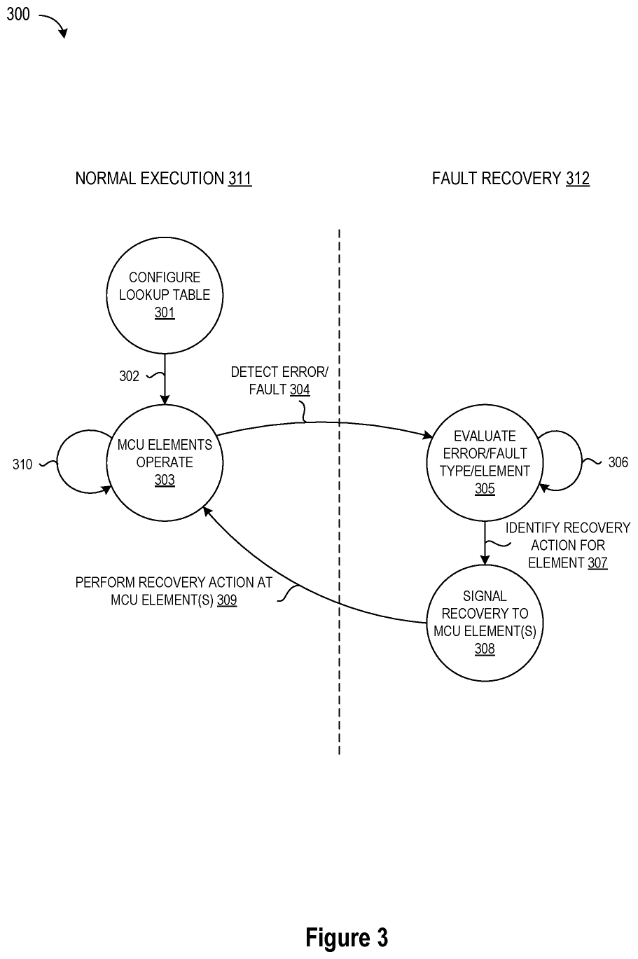

To provide additional details for an improved understanding of selected embodiments of the present disclosure, reference is now made to FIG. 3 which depicts a hardware state machine decision tree 300 which may be used by a fault collection and control unit to move between a normal execution mode 311 and a fault recovery mode 312 in the process of recovering from computer system errors and faults with a minimum disruption to system operations. As depicted, the hardware state machine decision tree 300 consists of four main states, including a configuration state 301, normal operation state 303, fault/error detection/evaluation state 305, and recovery state 308.

As part of (or prior to) the normal execution mode 311, the configuration state 301 refers to at least an initial state when a recovery lookup table is configured and/or programmed to define one or more recovery actions for specified computer system element faults or errors. As will be appreciated, the lookup table configuration state 301 may be implemented during initialization of the computer system but may also be periodically updated during the normal execution mode 311 to provide for a dynamically configurable recovery for the computer system.

Upon completion of the lookup table configuration (state transition 302), the hardware state machine decision tree proceeds to the normal operation state 303. In this state, the computer system may include a plurality of MCU elements which are all operating normally until such time as an error or fault is detected (state transition 304).

Upon detecting one or more faults or errors, the hardware state machine decision tree proceeds to the error/fault evaluation state 305. For example, if an MCU element issues a fault indication signal, the fault collection and control unit may evaluate the fault indication signal to determine which MCU element had the error/fault and also what type of error/fault was detected. As indicated by the repeat loop 306, a plurality of error/fault indications may be evaluated at the evaluation state 305 in cases there are multiple MCU elements which are affected by one or more errors or faults. As disclosed herein, the evaluation state 305 uses a recovery lookup table to identify a specific recovery action for the MCU element where the identified error/fault occurred.

Upon identifying a recovery action for one or more elements from the recovery lookup table (state transition 307), the hardware state machine decision tree proceeds to the recovery state 308. In this state, the fault collection and control unit may issue a signal to the MCU element where the error/fault occurred to perform one or more recovery actions specified by the recovery lookup table (state transition 309). At the applicable VM(s) or MCU element(s), the recovery action is performed to get to a known state, such as by resetting, restoring, flushing, blanking, stopping, or finishing the operations at the affected MCU element(s).

By specifying element-specific recovery actions as part of the evaluation state 305 and then signaling the recovery action(s) to the affected MCU element(s), the hardware state machine 300 enables selective recovery of individual MCU components without requiring recovery actions or system reset or restart operations for all MCU components on the computer system. In this way, if a fault/error has only occurred on one task in a single virtual machine or one element of the MCU (e.g., one area of memory, or one peripheral), then the hardware state machine enables offers a quicker, less disruptive way to get the system back to a known state. This can be advantageous, depending on the MCU and the use case, since each element on the MCU has a different way of getting to a known state. As will be appreciated, other variations of the hardware state machine decision tree 300 are envisioned within the scope and spirit of this disclosure.

By now it should be appreciated that there has been provided an apparatus, method, program code, and system for recovering from errors at one or more components of a microcontroller unit (MCU). In selected embodiments, an initial configuration (or reconfiguration) step may be applied to assign one or more first error recovery actions to at least a first component on the MCU, wherein each first recovery action specifies a component-specific operation for returning the first component to a known state to restart operation of the first component from the known state. As part of the initial configuration (or reconfiguration), the one or more first error recovery actions for the first component are stored in a recovery lookup table, such as a content addressable recovery lookup table. In selected embodiments, the first error recovery actions are selected from a group consisting of a restore action, a finish action, a blank action, a stop action, and a finish action. In the initial configuration (or reconfiguration), one or more second error recovery actions may be assigned to at least a second component on the MCU and stored in the recovery lookup table, wherein each second recovery action specifies a component-specific operation for returning the second component to a known state to restart operation of the second component from the known state. As a result, the recovery lookup table may be configured to store, for each of a plurality of different components on the MCU, one or more error recovery actions which each specify a component-specific operation for returning a corresponding component to a known state to restart operation of the corresponding component from the known state. Subsequently during normal operation of the MCU, an error signal from the first component may be received by a fault collection and control unit (FCCU) which may be part of the MCU. In selected embodiments, the error signal is issued by the first component to indicate a failure of a transaction at the first component. At the FCCU, the error signal is evaluated to determine an error type and location for the first component. In addition, the error type and location for the first component may be applied by the FCCU to the recovery lookup table to retrieve the one or more first error recovery actions for the first component. By applying the one or more first error recovery actions at the first component, the first component is returned to the known state without restarting all other components on the MCU. In selected embodiments, the FCCU includes a hardware state machine for evaluating the error signal and applying the error type and location for the first component to the recovery lookup table to retrieve the one or more first error recovery actions for the first component.

In another form, there is provided a data processing system, apparatus, method, and program code, for recovering from errors at one or more data processing system elements. In selected embodiments, the one or more data processing system elements are selected from the group consisting of a virtual machine, a core, a direct memory access controller, an interconnect but, a flash memory, a random access memory, a timer, and a communications peripheral. The data processing system includes a dynamically configurable recovery engine connected to receive error signals from the one or more data processing system element. The error signal may be issued by each data processing system element to indicate a failure of a transaction at the data processing system element. In selected embodiments, the recovery engine is embodied as a fault collection and control unit. The recovery engine includes a recovery lookup table for storing, for each data processing system element, one or more error recovery actions which specify an element-specific operation for returning a corresponding data processing system element to a known state to restart operation of the corresponding data processing system element from the known state. In selected embodiments, the recover lookup table is embodied as a content addressable memory. In addition, the one or more first error recovery actions may be selected from a group consisting of a restore action, a finish action, a blank action, a stop action, and a finish action. The recovery engine also includes a hardware state machine configured to evaluate a first error signal received from a first data processing system element to determine an error type and location and to apply the error type and location for the first data processing system element to the recovery lookup table to retrieve one or more first error recovery actions for the first data processing system element which are applied at the first data processing system element to return the first data processing system element to the known state without restarting all other data processing system elements. In selected embodiments, the hardware state machine is further configured to transfer the one or more first error recovery actions from the recovery look up table to the first data processing system element. In addition, each data processing system element may include built-in circuitry for acting on the one or more first error recovery actions.

In yet another form, there is provided a microelectronic circuit, system, apparatus, method, and program code. The microelectronic circuit includes a plurality of microelectronic circuit elements, each comprising at least one component configured to generate an error signal when a fault occurs at the microelectronic circuit element, where each microelectronic circuit element is individually resettable during a restart of the microelectronic circuit. In addition, each microelectronic circuit element may include built-in circuitry for acting on one or more first error recovery actions. The microelectronic circuit also includes an interconnect bus in electrical communication with each of the plurality of microelectronic circuit elements. In addition, the microelectronic circuit includes a reset controller electrically connected to the interconnect bus to receive error signals from the plurality of microelectronic circuit elements. In particular, the reset controller includes a recovery lookup table for storing, for each microelectronic circuit element, one or more error recovery actions which specify an element-specific operation for returning a corresponding microelectronic circuit element to a known restart state from the known state. In addition, the reset controller includes a hardware state machine configured to evaluate a first error signal received from a first microelectronic circuit element to determine an error type and location and to apply the error type and location for the first microelectronic circuit element to the recovery lookup table to retrieve one or more first error recovery actions for the first microelectronic circuit element which are applied at the first microelectronic circuit element to return the first microelectronic circuit element to the known state without restarting all other microelectronic circuit elements. In selected embodiments, the hardware state machine is further also to transfer the one or more first error recovery actions from the recovery look up table to the first microelectronic circuit element. In selected embodiments, the one or more first error recovery actions are selected from a group consisting of a restore action, a finish action, a blank action, a stop action, and a finish action. In addition, each of the plurality of microelectronic circuit elements is selected from the group consisting of a virtual machine, a core, a direct memory access controller, an interconnect but, a flash memory, a random access memory, a timer, and a communications peripheral.

Although the described exemplary embodiments disclosed herein are directed to specific embodiments, the present invention is not necessarily limited to the example embodiments illustrate herein, and various embodiments of the circuitry and methods disclosed herein may be implemented with other devices and circuit components. Thus, the embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

Various illustrative embodiments of the present invention have been described in detail with reference to the accompanying figures. While various details are set forth in the foregoing description, it will be appreciated that the present invention may be practiced without these specific details, and that numerous implementation-specific decisions may be made to the invention described herein to achieve the circuit designer's specific goals, such as compliance with process technology or design-related constraints, which will vary from one implementation to another. While such a development effort might be complex and time-consuming, it would nevertheless be a routine undertaking for those of ordinary skill in the art having the benefit of this disclosure. For example, selected aspects are shown in block diagram form, rather than in detail, in order to avoid limiting or obscuring the present invention. In addition, some portions of the detailed descriptions provided herein are presented in terms of algorithms or operations on data within a computer memory. Such descriptions and representations are used by those skilled in the art to describe and convey the substance of their work to others skilled in the art.

Benefits, other advantages, and solutions to problems have been described above regarding specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for recovering from errors at one or more components of a microcontroller unit (MCU) comprising:
assigning one or more first error recovery actions to at least a first component on the MCU, wherein each first recovery action specifies a component-specific operation for returning the first component to a known state to restart operation of the first component from the known state;
storing the one or more first error recovery actions for the first component in a recovery lookup table;
receiving, by a fault collection and control unit (FCCU), an error signal from the first component;
evaluating the error signal at the FCCU to determine an error type and location for the first component;
applying the error type and location for the first component to the recovery lookup table to retrieve the one or more first error recovery actions for the first component; and
applying the one or more first error recovery actions at the first component to return the first component to the known state without restarting all other components on the MCU.

2. The method of claim 1, further comprising:
assigning one or more second error recovery actions to at least a second component on the MCU, wherein each second recovery action specifies a component-specific operation for returning the second component to a known state to restart operation of the second component from the known state;
storing the one or more second error recovery actions for the second component in the recovery lookup table.

3. The method of claim 1, where storing the one or more first error recovery actions comprises storing one or more first error recovery actions in a content addressable recovery lookup table.

4. The method of claim 1, where the recovery lookup table stores, for each of a plurality of different components on the MCU, one or more error recovery actions which each specify a component-specific operation for returning a corresponding component to a known state to restart operation of the corresponding component from the known state.

5. The method of claim 1, where the one or more first error recovery actions are selected from a group consisting of a restore action, a finish action, a blank action, a stop action, and a finish action.

6. The method of claim 1, where the error signal is issued by the first component to indicate a failure of a transaction at the first component.

7. The method of claim 1, wherein the FCCU comprises a hardware state machine for evaluating the error signal and applying the error type and location for the first component to the recovery lookup table to retrieve the one or more first error recovery actions for the first component.

8. A data processing system, comprising:
one or more data processing system elements; and
a dynamically configurable recovery engine connected to receive error signals from the one or more data processing system element, comprising:
a recovery lookup table for storing, for each data processing system element, one or more error recovery actions which specify an element-specific operation for returning a corresponding data processing system element to a known state to restart operation of the corresponding data processing system element from the known state, and
a hardware state machine configured to evaluate a first error signal received from a first data processing system element to determine an error type and location and to apply the error type and location for the first data processing system element to the recovery lookup table to retrieve one or more first error recovery actions for the first data processing system element which are applied at the first data processing system element to return the first data processing system element to the known state without restarting all other data processing system elements.

9. The data processing system of claim 8, where the dynamically configurable recovery engine comprises a fault collection and control unit.

10. The data processing system of claim 8, where hardware state machine is further configured to transfer the one or more first error recovery actions from the recovery look up table to the first data processing system element.

11. The data processing system of claim 8, where the first data processing system element comprises built-in circuitry for acting on the one or more first error recovery actions.

12. The data processing system of claim 8, where the recover lookup table comprises a content addressable memory.

13. The data processing system of claim 8, where the one or more first error recovery actions are selected from a group consisting of a restore action, a finish action, a blank action, a stop action, and a finish action.

14. The data processing system of claim 8, where the error signal is issued by the first data processing system element to indicate a failure of a transaction at the first data processing system element.

15. The data processing system of claim 8, wherein the one or more data processing system elements are selected from the group consisting of a virtual machine, a core, a direct memory access controller, an interconnect but, a flash memory, a random access memory, a timer, and a communications peripheral.

16. A microelectronic circuit, comprising:
a plurality of microelectronic circuit elements, each comprising at least one component configured to generate an error signal when a fault occurs at the microelectronic circuit element, where each microelectronic circuit element is individually resettable during a restart of the microelectronic circuit;
an interconnect bus in electrical communication with each of the plurality of microelectronic circuit elements; and
a reset controller electrically connected to the interconnect bus to receive error signals from the plurality of microelectronic circuit elements, the reset controller comprising:
a recovery lookup table for storing, for each microelectronic circuit element, one or more error recovery actions which specify an element-specific operation for returning a corresponding microelectronic circuit element to a known restart state from the known state, and
a hardware state machine configured to evaluate a first error signal received from a first microelectronic circuit element to determine an error type and location and to apply the error type and location for the first microelectronic circuit element to the recovery lookup table to retrieve one or more first error recovery actions for the first microelectronic circuit element which are applied at the first microelectronic circuit element to return the first microelectronic circuit element to the known state without restarting all other microelectronic circuit elements.

17. The microelectronic circuit of claim 16, where hardware state machine is further configured to transfer the one or more first error recovery actions from the recovery look up table to the first microelectronic circuit element.

18. The microelectronic circuit of claim 16, where the microelectronic circuit element comprises built-in circuitry for acting on the one or more first error recovery actions.

19. The microelectronic circuit of claim 16, where the one or more first error recovery actions are selected from a group consisting of a restore action, a finish action, a blank action, a stop action, and a finish action.

20. The microelectronic circuit of claim 16, where each of the plurality of microelectronic circuit elements is selected from the group consisting of a virtual machine, a core, a direct memory access controller, an interconnect but, a flash memory, a random access memory, a timer, and a communications peripheral.
